(19) United States
(12) Patent Application Publication
(10) Pub. No.: US 2009/0038650 A1
(43) Pub. Date: Feb. 12, 2009

(54) Compositions and substrate cleaning methods

(76) Inventors: Ronald Grogan, Spokane, WA (US); Frank Maresca, Lewiston, ID (US)

Correspondence Address: WELLS ST. JOHN P.S., 601 W. FIRST AVENUE, SUITE 1300, SPOKANE, WA, 99201, US

(21) Appl. No.: 11/891,489

(22) Filed: Aug. 10, 2007

(51) Int. Cl. B08B 3/08; C11D 3/20

(52) U.S. Cl. 134/38; 510/491

(57) ABSTRACT

Compositions are provided that can include a fatty acid ester such as canolates, and essential oils such as borneol. Example compositions can include a canolate and lime oil. Methods for cleaning substrates are also provided that can include exposing the substrate to a mixture including a fatty acid ester and an essential oil. Methods for dissolving a primarily organic substance are also provided that can include exposing the substance to a mixture including a fatty acid ester and an essential oil. Particular methods are provided for cleaning painting equipment that can include exposing the painting equipment to a composition comprising a fatty acid ester and an essential oil.

### TECHNICAL FIELD

The present disclosure relates to novel compositions and methods, and more particularly to compositions and substrate cleaning methods.

### BACKGROUND OF THE DISCLOSURE

Cleaning compositions and mixtures have long been utilized to remove unwanted substances from substrates. Today the unwanted substances are more difficult to remove than ever before. Acrylics, industrial greases, even the previous compositions and mixtures themselves that have been developed to remove these unwanted substances are difficult to dispose of and/or remove. In some instances, the cleaning compositions and mixtures themselves can have characteristics that are just as noxious as the waste products they are meant to remove, for example, paints. For example, the more durable some paints are, the more difficult it is to clean the supplies used to apply the paint or remove the paint once it is applied.

The fingernail polish industry, for example, has grown leaps and bounds in the past 15 years. Metric tons of acetone are utilized on a daily basis to remove fingernail polish, yet this acetone is almost casually disposed of in a sink and directly into our publicly owned treatment works, where it causes a burden on the organic digestion processes at those works. The present disclosure provides compositions and mixtures that, according to example embodiments, can be utilized to remove these waste materials from substrates. At least one of the benefits of some of the embodiments of the compositions and mixtures is that the composition and mixture is biodegradable and may also manufactured from readily renewable resources.

### SUMMARY OF THE DISCLOSURE

Compositions are provided that can include a fatty acid ester such as canolates, and essential oils such as borneol. Example compositions can include a canolate and lime oil.

Methods for cleaning substrates are also provided that can include exposing the substrate to a mixture including a fatty acid ester and an essential oil. Methods for dissolving a primarily organic substance are also provided that can include exposing the substance to a mixture including a fatty acid ester and an essential oil. Particular methods are provided for cleaning painting equipment that can include exposing the painting equipment to a composition comprising a fatty acid ester and an essential oil.

### DESCRIPTION

This disclosure of the invention is submitted in furtherance of the constitutional purposes of the U.S. Patent Laws “to promote” the progress of science and useful arts” (Article 1, Section 8).

The present disclosure provides compositions and/or mixtures that can be utilized as a parts washer solvent, nail polish remover, utilized in power washing, as a paintbrush and paint roller cleaner, as an air brush paint gun cleaner, as a rust remover, as a scale remover, as an engine degreaser, as a tank cleaner, as a degreaser, as a paint cleanup solution, as a heavy lube cleanup solution, as a graphic and inkjet printer cleaning applications, as well as an eyelash adhesive remover. While being utilized in the far-reaching and varied scope described previously, the use of the compositions and/or mixtures can be ecologically advantageous as embodiments of the compositions and mixtures are biodegradable and/or produced from a renewable resource rather than petroleum industry based. Embodiments of the compositions and/or mixtures may be utilized and replace a multitude of cleaning products which are harmful to the environment and human health. The compositions and/or mixtures are agriculturally based, contributing to the demand for farm commodities in various regions and supporting healthy pricing levels to area farm growers. Components of the compositions and/or mixtures may be acquired in the Pacific Northwest, for example.

Embodiments of the compositions and/or mixtures do not necessitate synthesis, are safe for use without special protective equipment, and result in compositions and/or mixtures that can, according to exemplary embodiments, demonstrate superior cleaning as a solvent solution that may also be used in a variety of applications. Embodiments of the compositions and/or mixtures may have a high flash point which can be desirable for consumer needs and is unique to the industry.

According to an example embodiment, the present disclosure provides compositions and/or mixtures that can include a fatty acid ester and borneol. The fatty acid ester mixture can be acquired as from a planter material dry extrusion process utilizing friction as the source of heat to sterilize and/or dehydrate products. The fatty acids of the plant material can be fully geletanized using this process, for example. Soy bean plant material cell walls can be completely ruptured during dry extrusion and the extraction can be chemically free rather than using hexane, for example.

The fatty acid ester can be provided in the form of a fatty acid ester mixture. For example, the fatty acid ester can be a component of a canolate composition, including canola methyl esters. Canolate compositions typically include fatty acid esters of palmitic, stearic, oleic, linoleic, linolenic, eicosenoic, erucic, and other miscellaneous acid esters. The fatty acid ester can be a canolate, a palmatate, and/or soyate. The ester of these fatty acids could be methyl esters and/or ethyl esters, a mixture of these esters, or any other type of ester that may be commonly utilized. Exemplary fatty esters can also be components of compositions commonly referred to as biodiesel or production compositions used in the manufacturing of biodiesel. The fatty acid esters can be acquired at, for example, Technical Holdings LLC Air Energy, 1010 S. Pioneer Way, Moses Lake, Wash. 98837; and/or Chemcentral, 6308 E. Sharp Avenue, Spokane, Wash. 99212-1282.

Borneol can be supplied in the form of an essential oil such as lime oil. Accordingly, the composition and/or mixture of the present disclosure can include a canolate and lime oil. In accordance with other implementations, the compositions and/or mixtures can include a fatty acid ester and an essential oil. As an example, the essential oil can be a lime oil and/or a pine oil. The essential oils can be acquired at, for example, the University of Idaho Biological and Agricultural Engineering Department, JML 74, Moscow, Id. 83844-2060; Technical Holdings LLC Air Energy, 1010 S. Pioneer Way, Moses Lake, Wash. 98837; and/or Chemcentral, 6308 E. Sharp Avenue, Spokane, Wash. 99212-1282.

In accordance with exemplary embodiments, the fatty acid ester mixture, such as a canolate can be at least about 79% of the composition by weight. The fatty acid ester mixture can also be from about 79% to about 99% of the composition by weight, or less than 99% of the composition by weight. In accordance with exemplary aspects, the lime oil or essential oil component of the composition can be at least 1% of the composition by weight, or from about 1% to about 5% of the composition by weight. The lime oil can be less than 5% of the composition by weight.

The composition may further include an antioxidant such as the antioxidant 2-(1,1-dimethylethyl)-1,4-benzenediol. In accordance with another example composition, the fatty acid ester mixture such as the canolate can be at least about 79% of the composition by weight, the essential oil such as the lime oil can be at least about 1% of the composition by weight, and the antioxidant such as the 2-(1,1-dimethylethyl)-1,4-benzenediol can be at least about 0.5% of the composition by weight. In accordance with another exemplary composition, the fatty acid ester mixture such as the canolate can be at least about 79% of the composition by weight, the essential oil such as the lime oil can be at least about 1% of the composition by weight, and another essential oil such as the pine oil can be at least about 0.5% of the composition by weight.

According to another example embodiment of the composition, the fatty acid ester mixture such as canolate is at least about 79% of the composition by weight, the essential oil such as the lime oil is at least about 1% of the composition by weight, and another essential oil such as the pine oil is from about 0.5% to about 15% of the composition by weight.

These compositions and/or mixtures can be used to clean a substrate. For example, a method for cleaning a substrate can include exposing the substrate to a mixture comprising a fatty acid ester mixture and an essential oil. According to an exemplary embodiment, the substrate can be a painting tool and can be at least partially covered with paint. The method can include dissolving at least a portion of the paint within the mixture to create a waste mixture comprising the fatty acid ester and a portion of the paint. According to another embodiment, the substrate can be a biological mass such as a fingernail. The fingernail may be in fact covered with paint. The method may include disposing of the waste mixture, for example, by utilizing the waste mixture as a fuel during a combustion process.

According to yet another embodiment, a method for dissolving a primarily organic substance utilizing the composition can include exposing the substance to a mixture comprising the fatty acid ester and an essential oil. According to exemplary embodiments, the fatty acid ester can be a methyl ester and the fatty acid can also be a methyl ester of a canola oil. In accordance with another aspect of the present disclosure, the essential oil of the mixture can include lime oil and as such can also include the compound borneol. According to a more particular embodiment, the fatty acid ester can be a canolate and the essential oil can be lime oil. Accordingly, methods are provided for cleaning painting equipment comprising exposing the painting equipment to a composition comprising a fatty acid and an essential oil.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A composition comprising:
a fatty acid ester; and
borneol.

2. The composition of claim 1 wherein the fatty acid ester is a component of a canolate.

3. The composition of claim 1 wherein the fatty acid ester is a component of a canolate, and the canolate is a canola methyl ester.

4. The composition of claim 1 wherein the fatty acid ester is a fatty acid methyl ester.

5. The composition of claim 1 wherein the borneol is a component of an essential oil.

6. The composition of claim 1 wherein the borneol is a component of lime oil.

7. The composition of claim 1 further comprising an antioxidant.

8. The composition of claim 7 wherein the antioxidant comprises 2-(1,1-dimethylethyl)-1,4-benzenediol.

9. A composition comprising:
a canolate; and
lime oil.

10. The composition of claim 9 wherein the canolate is at least 79% of the composition by weight.

11. The composition of claim 9 wherein the canolate is from about 79% to about 99% of the composition by weight.

12. The composition of claim 9 wherein the canolate is less than 99% by weight of the composition.

13. The composition of claim 9 wherein the lime oil is at least 1% of the composition by weight.

14. The composition of claim 9 wherein the lime oil is from about 1% to about 5% of the composition by weight.

15. The composition of claim 9 wherein the lime oil is less than 5% of the composition by weight.

16. The composition of claim 9 further comprising one or both of an antioxidant and pine oil.

17. The composition of claim 16 wherein:
the canolate is at least 79% of the composition by weight;
the lime oil is at least 1% of the composition by weight; and
the antioxidant is at least 0.5% of the composition by weight.

18. The composition of claim 16 wherein:
the canolate is at least 79% of the composition by weight;
the lime oil is at least 1% of the composition by weight; and
the pine oil is at least 0.5% of the composition by weight.

19. The composition of claim 16 wherein:
the canolate is at least 79% of the composition by weight;
the lime oil is at least 1% of the composition by weight; and
the pine oil is from about 0.5% to about 15% of the composition by weight.

20. A method for cleaning a substrate, comprising exposing the substrate to a mixture comprising a fatty acid ester and an essential oil.

21. The method of claim 20 wherein a portion of the substrate is at least partially covered with paint.

22. The method of claim 21 further comprising dissolving at least a portion of the paint with the mixture to create a waste mixture comprising the fatty acid ester and the portion of the paint.

23. The method of claim 22 further comprising disposing of the waste mixture.

24. The method of claim 23 wherein the disposing comprises utilizing the waste mixture as fuel during a combustion process.

25. A method for dissolving a primarily organic substance, comprising exposing the substance to a mixture comprising a fatty acid ester and an essential oil.

26. The method of claim 25 wherein the fatty acid ester is a methyl ester.

27. The method of claim 26 wherein the fatty acid ester is a methyl ester of canola oil.

28. The method of claim 25 wherein the essential oil comprises borneol.

29. The method of claim 25 wherein:
the fatty acid ester is a canolate; and
the essential oil is lime oil.

30. A method for cleaning painting equipment comprising exposing the painting equipment to a composition comprising a fatty acid ester and an essential oil.
